(19) United States
(12) Patent Application Publication
(10) Pub. No.: US 2015/0194761 A1
(43) Pub. Date: Jul. 9, 2015

(54) WATER-PROOF CONNECTOR

(71) Applicant: Cheng Uei Precision Industry Co., Ltd., New Taipei City (TW)

(72) Inventors: BAO-GENG XIE, Dong-Guan City (CN); WEI-HONG LIAO, Dong-Guan City (CN); YIN-LUNG WU, New Taipei City (TW)

(73) Assignee: Cheng Uei Precision Industry Co., Ltd., New Taipei City (TW)

(21) Appl. No.: 14/150,765

(22) Filed: Jan. 8, 2014

(51) Int. Cl. H01R 13/52

(52) U.S. Cl. CPC H01R 13/52

(57) ABSTRACT

A water-proof connector includes an internal housing, a plurality of terminals, an internal shell, an external shell, an external housing and a sealing ring. The internal housing has a base portion and a tongue board. The tongue board defines a plurality of terminal grooves which the terminals are integrated in thereof. The internal shell has a top wall, a bottom wall and two side walls which corporately define a receiving chamber for receiving the internal housing and the terminals. The external shell has a top plate, a rear plate and two side plates which enclose two sides of the internal shell and the rear of the internal housing. The external housing has a top board, a bottom board, a rear board and two side boards which corporately define a receiving cavity for receiving the internal housing, internal shell and external shell. The sealing ring sheathes outside the external housing.

### BACKGROUND OF THE INVENTION

1. Field of the Invention

The present invention relates to a connector, and more particularly to a water-proof connector.

2. The Related Art

A traditional water-proof connector includes an internal housing, a plurality of terminals, an external shell, an external housing and a sealing ring. The terminals are integrated in the internal housing. The external shell sheathes outside the internal housing. The external housing is molded outside the internal housing and the external shell. The sealing ring is worn around the external housing.

However, the traditional water-proof connector is easily burst the rear wall of the external housing by the high pressure of the water. So inventor need to provide a high grade of water-proof connector to resolve the defect of the traditional water-proof connector.

### SUMMARY OF THE INVENTION

Accordingly, an object of the present invention is to provide a water-proof connector. The water-proof connector includes an internal housing, a plurality of terminals, an internal shell, an external shell, an external housing and a sealing ring. The internal housing has a base portion. A front of the base portion extends frontward to form a tongue board with a smaller dimension than the base portion. A bottom face of the tongue board defines a plurality of terminal grooves arranged at regular intervals along the transverse direction and each penetrating vertically through the bottom face of the base portion. A plurality of terminals integrated in the terminal grooves of the internal housing. The internal shell has a top wall, a bottom wall and two side walls which corporately define a receiving chamber for receiving the internal housing and the terminals therein. The external shell has a top plate. A rear edge and two side edges of the top plate protrude downward to form a rear plate and two side plates. The external shell encloses two sides of the internal shell and the rear of the internal housing. The external housing has a top board, a bottom board, a rear board and two side boards which corporately define a receiving cavity for receiving the internal housing, internal shell and external shell therein. The sealing ring sheathes an outside of a front end of the external housing.

As described above, the embodiment of the invention of the water-proof connector by virtue of the sealing ring seals off the opening of the water-proof connector to prevent the water into the interior of the water-proof connector, the external housing is molded outside the internal housing, the internal shell and the external shell, the internal housing is received in the receiving chamber of the internal shell, and the external shell encloses two sides of the internal shell and the rear of the internal housing to provide enough strength to resist the water impacting, with the purpose of reaching a high grade of water-proof ingress protection.

### BRIEF DESCRIPTION OF THE DRAWINGS

The present invention will be apparent to those skilled in the art by reading the following description thereof, with reference to the attached drawings, in which:

FIG. 1 is an assembled, perspective view of a water-proof connector in accordance with an embodiment of the present invention;

FIG. 2 is an exploded, perspective view of the water-proof connector shown in FIG. 1;

FIG. 3 is a perspective view of the first injection molding of the water-proof connector shown in FIG. 1;

FIG. 4 is a perspective view of the water-proof connector with internal shell shown in FIG. 3;

FIG. 5 is a perspective view of the water-proof connector with external shell shown in FIG. 4; and

FIG. 6 is an upward view of the water-proof connector shown in FIG. 1.

### DETAILED DESCRIPTION OF THE EMBODIMENT

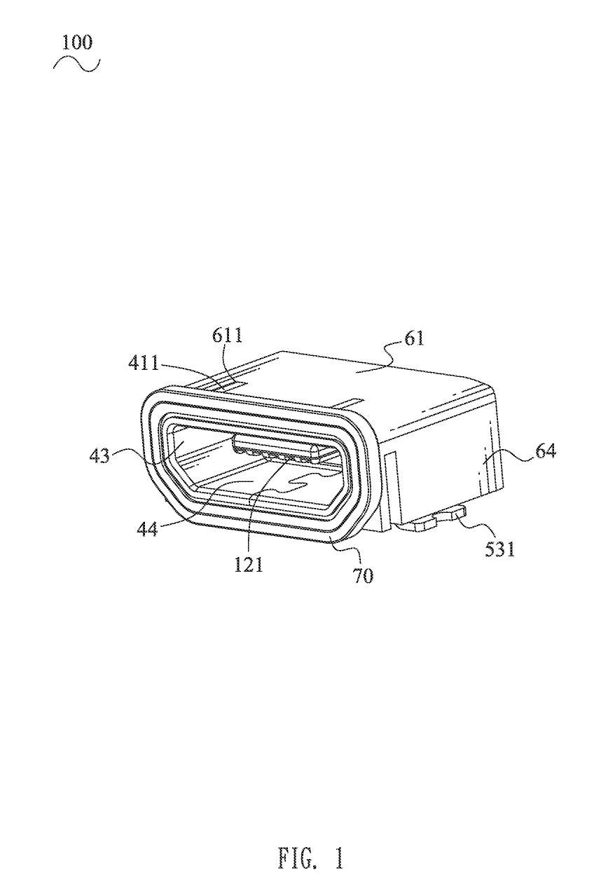

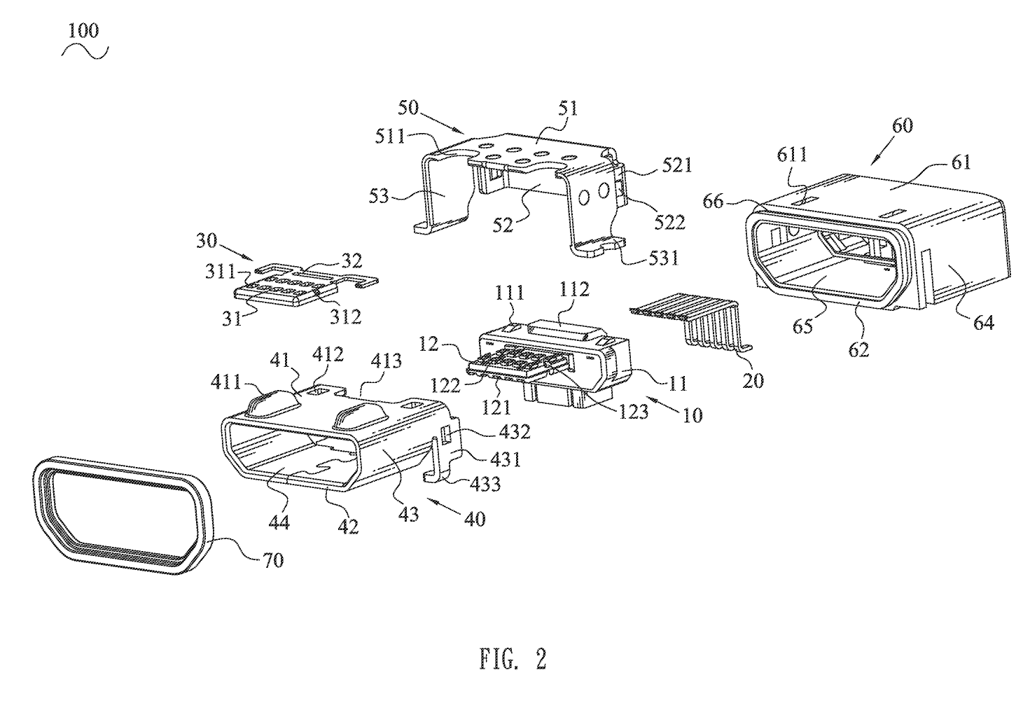

With reference to FIG. 1 and FIG. 2, an embodiment of the present invention is shown as a water-proof connector 100 includes an internal housing 10, a plurality of terminals 20, a stiffening cap 30, an internal shell 40, an external shell 50, an external housing 60 and a sealing ring 70.

Referring to FIG. 2, the internal housing 10 has a base portion 11. A front of the base portion 11 extends frontward to form a tongue board 12 with a smaller dimension than the base portion 11. Two opposite sides of a top face of the base portion 11 protrude upward to form a pair of fastening lumps 111. A center of a top face, a rear face and a bottom face of the base portion 11 protrude outward and connects to each other to form a blocking lump 112. A bottom face of the tongue board 12 defines a plurality of terminal grooves 121 arranged at regular intervals along the transverse direction and each penetrating vertically through the bottom face of the base portion 11. A top face of the tongue board 12 protrudes upward to form a plurality of convex hulls 122. In the embodiment of the present of the water-proof connector 100, the convex hull 122 is ring-shaped. Two opposite sides of a top face of the tongue board 12 connecting to the side edges of the tongue board 12 protrude outward to form a pair of fixing lumps 123.

The terminal 20 are integrated in the terminal grooves 121 of the internal housing 10.

The stiffening cap 30 has a stiffening board 31. A rear edge of the stiffening board 31 extends rearward and further extends to two sides in transverse direction to form a pair of fixing boards 32. A front edge and two side edges of the stiffening board 31 protrude downward and connecting with each other to form a cap structure. The stiffening board 31 defines a plurality of opening slots 311 corresponding to the convex hulls 122 of the tongue board 12 of the internal housing 10, and the convex hulls 122 of the tongue board 12 of the internal housing 10 are fastened in the opening slots 311 of the stiffening board 31 of the stiffening cap 30. The stiffening board 31 defines a pair of fixing slots 312 corresponding to the fixing lumps 123 of the tongue board 12 of the internal housing 10. The fixing lumps 123 of the tongue board 12 of the internal housing 10 are fastened in the fixing slots 312 of the stiffening board 31.

The internal shell 40 sheathes outside the internal housing 10. The internal shell 40 has a top wall 41, a bottom wall 42 and two side walls 43 which corporately define a receiving chamber 44 for receiving the internal housing 10 and the terminals 20 therein. Two opposite sides of a front end of the top wall 41 of the internal shell 40 stamp upward to form a pair of receiving shells 411. Two opposite sides of a rear end of the top wall 41 of the internal shell 40 define a pair of fastening slots 412 corresponding to the fastening lumps 111 of the base portion 11 of the internal housing 10. A rear edge of the top wall 41 of the internal shell 40 is concaved frontward to form a blocking slot 413. A rear edge of two side walls 43 of the internal shell 40 protrude rearward and further protrude downward to form a pair of clamping slices 431. The clamping slice 431 each defines a locking opening 432. A bottom end of each clamping slice 431 is bent inward to form a soldering tail 433.

The external shell 50 encloses the two sides of the internal shell 40 and the rear of the internal housing 10. The external shell 50 has a top plate 51. A rear edge and two side edges of the top plate 51 protrude downward to form a rear plate 52 and two side plates 53. A front edge of the top plate 51 of the external shell 50 defines a pair of receiving slots 511 corresponding to the receiving shells 411 of the top wall 41 of the internal shell 40. Two opposite edges of the rear plate 52 of the external shell 50 is bent frontward and extended to form a pair of accepting slices 521 and each accepting slice 521 is punched outward to form an elastic slice 522. A bottom edge of two side plates 53 is bent outward and extended respectively to form a pair of soldering pins 531.

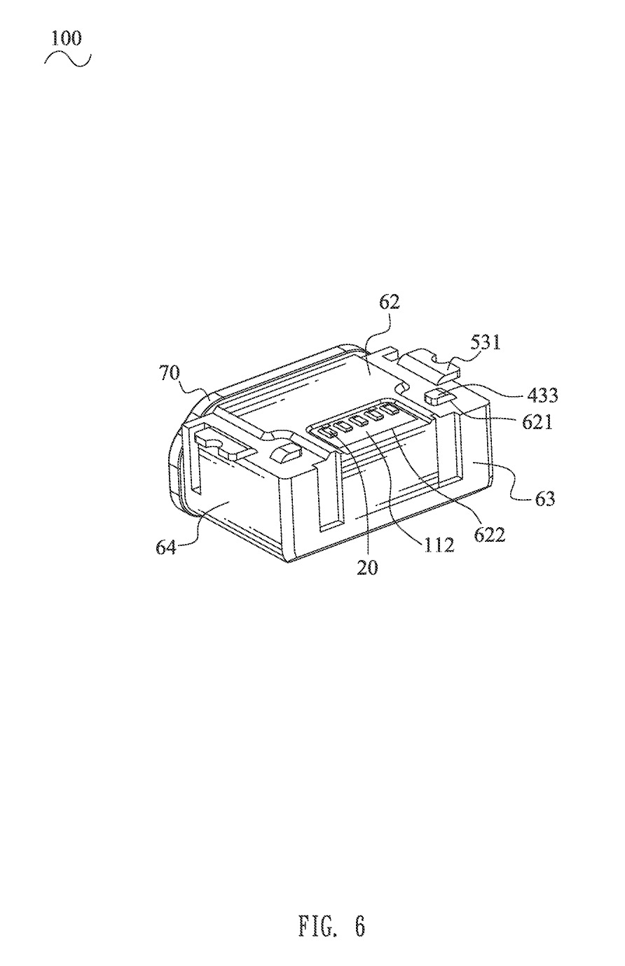

Referring to FIGS. 2 and 6, the external housing 60 is molded outside of the internal housing 10, the internal shell 40 and external housing 50. The external housing 60 has a top board 61, a bottom board 62, a rear board 63 and two side boards 64 which corporately define a receiving cavity 65 for receiving the internal housing 10, internal shell 40 and external shell 50 therein. The top board 61 of the external housing 60 defines a pair of receiving holes 611 corresponding to the receiving shells 411 of the top wall 41 of the internal shell 40. The bottom board 62 of the external housing 60 defines a plurality of soldering tail holes 621 corresponding to the soldering tails 433 of the side wall 43 of the internal shell 40 and the soldering pins 531 of the side plates 53 of the external shell 50. The bottom board 62 of the external housing 60 defines a containing slot 622 corresponding to the blocking lump 112 of the bottom face of the base portion 11 of the internal housing 10. A front end of the top face of the top board 61, the bottom face of the bottom board 62 and the side faces of two side boards 63 are concaved around to form a sealing slot 66.

The sealing ring 70 sheathes an outside of a front end of the external housing 60 and the sealing ring 70 is thicker than the external housing 60.

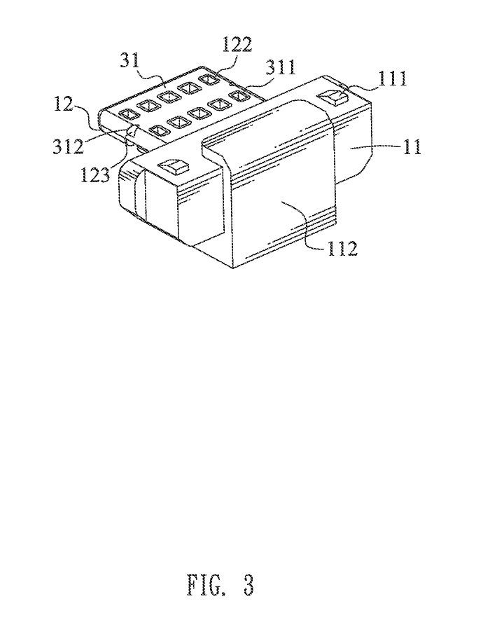

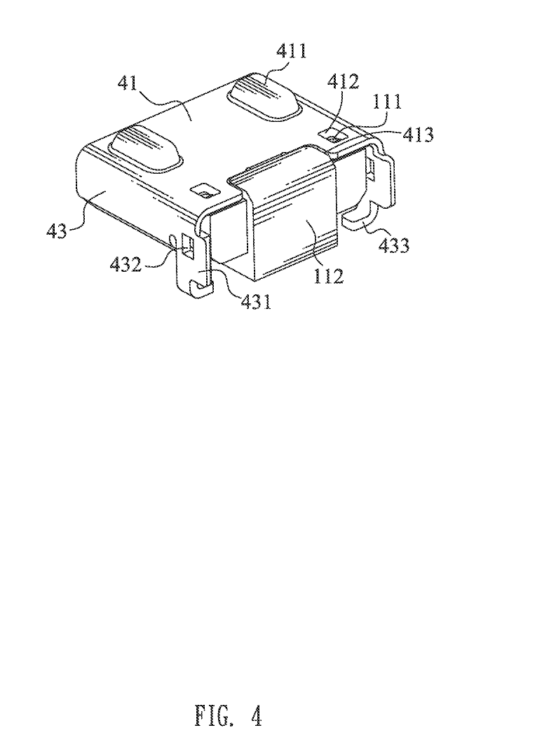

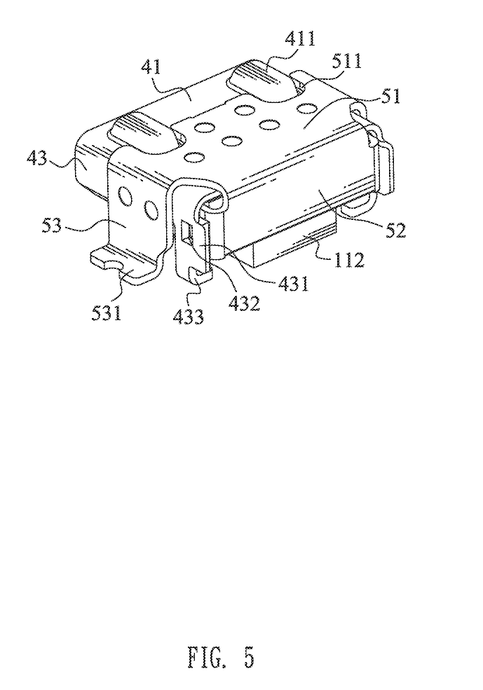

Referring to FIGS. 1 to 6, in assembly, the terminals 20 and the fixing board 32 of the stiffening cap 30 are integrated in the internal housing 10 by virtue of the terminals 20 are arranged at regular intervals along the transverse direction and the stiffening cap 30 are located above the terminals 20, the ends of the terminals 20 are projecting downward beyond the bottom face of the internal housing 10.

The internal shell 40 sheathes frontward outside the internal housing 10. The blocking lump 112 in the top face of the base portion 11 of the internal housing 10 is blocked in the blocking slots 413 of the top wall 41 of the internal shell 40. The fastening lumps 111 of the base portion 11 of the internal housing 10 are fastened in the fastening slots 412 of the top wall 41 of the internal shell 40.

The external shell 50 encloses frontward two sides of the internal shell 40 and the rear end of the internal housing 10. The accepting slices 521 of the rear plate 52 of the external shell 50 are held in the gap between the internal housing 10 and the internal shell 40. The elastic slices 522 of the accepting slices 521 of the external shell 50 are locked in the locking openings 432 of the side walls 43 of the internal shell 40. The receiving shells 411 of the top wall 41 of the internal shell 40 are received in the receiving slots 511 of the top plate 51 of the external shell 50. In the embodiment of the present of the water-proof connector 100, the external shell 50 spots welding on the internal shell 40 by laser.

The external housing 60 is molded outside the internal housing 10, the internal shell 40 and the external shell 50. The receiving shells 411 of the top wall 41 of the internal shell 40 are molded in the receiving holes 611 of the top board 61 of the external housing 60. The soldering tails 433 of the side walls 43 of the internal shell 40 and the soldering pins 531 of the side plates 53 of the external shell 50 are projecting downward beyond the soldering tail holes 621 of the bottom board 62 of the external housing 60. The blocking lump 112 in the bottom face of the base portion 11 of the internal housing 10 is received in the containing slot 622 of the bottom board 62 of the external housing 60.

The sealing ring 70 is embedded in the sealing slot 66 of the external housing 60.

As described above, the embodiment of the invention of the water-proof connector 100 by virtue of the sealing ring 70 seals off the opening of the water-proof connector 100 to prevent the water into the interior of the water-proof connector 100, the external housing 60 is molded outside the internal housing 10, the internal shell 40 and the external shell 50, the internal housing 10 is received in the receiving chamber 44 of the internal shell 40, and the external shell 50 encloses two sides of the internal shell 40 and the rear end of the internal housing 10 to provide enough strength to resist the water impacting, with the purpose of reaching a high grade of water-proof ingress protection.

What is claimed is:

1. A water-proof connector, comprising:
an internal housing having a base portion, a front of the base portion extending frontward to form a tongue board with a smaller dimension than the base portion, a bottom face of the tongue board defining a plurality of terminal grooves arranged at regular intervals along the transverse direction and each penetrating vertically through the bottom face of the base portion;
a plurality of terminals integrating in the terminal grooves of the internal housing;
an internal shell having a top wall, a bottom wall and two side walls which corporately define a receiving chamber for receiving the internal housing and the terminals therein;
an external shell having a top plate, a rear edge and two side edges of the top plate protruding downward to form a rear plate and two side plates, the external shell enclosing two sides of the internal shell and the rear of the internal housing;
an external housing having a top board, a bottom board, a rear board and two side boards which corporately define a receiving cavity for receiving the internal housing, internal shell and external shell therein; and
a sealing ring sheathing an outside of a front end of the external housing.

2. The water-proof connector as claimed in claim 1, wherein a center of a top face, a rear face and a bottom face of the base portion protruding outward and connecting to each other to form a blocking lump, a rear edge of the top wall of the internal shell being concaved frontward to form a blocking slot, the blocking lump in the top face of the base portion of the internal housing is blocked in the blocking slots of the top wall of the internal shell.

3. The water-proof connector as claimed in claim 1, wherein two opposite sides of a top face of the base portion protruding upward to form a pair of fastening lumps, two opposite sides of a rear end of the top wall of the internal shell defining a pair of fastening slots corresponding to the fastening lumps of the base portion of the internal housing, the fastening lumps of the base portion of the internal housing are fastened in the fastening slots of the top wall of the internal shell.

4. The water-proof connector as claimed in claim 1, wherein a rear edge of two side walls of the internal shell protruding rearward and further protruding downward to form a pair of clamping slices and the clamping slice each defining a locking opening, two opposite edges of the rear plate of the external shell being bent frontward and extended to form a pair of accepting slices and each accepting slice being punched outward to form an elastic slice, the elastic slices of the accepting slices of the external shell are locked in the locking openings of the side walls of the internal shell.

5. The water-proof connector as claimed in claim 1, wherein the external shell spots welding on the internal shell by laser.

6. The water-proof connector as claimed in claim 1, wherein two opposite sides of a front end of the top wall of the internal shell stamping upward to form a pair of receiving shells, a front edge of the top plate of the external shell defining a pair of receiving slots corresponding to the receiving shells of the top wall of the internal shell, the receiving shells of the top wall of the internal shell are received in the receiving slots of the top plate of the external shell.

7. The water-proof connector as claimed in claim 6, wherein the top board of the external housing defining a pair of receiving holes corresponding to the receiving shells of the top wall of the internal shell, the receiving shells of the top wall of the internal shell are molded in the receiving holes of the top board of the external housing.

8. The water-proof connector as claimed in claim 1, wherein a front end of the top face of the top board, the bottom face of the bottom board and the side faces of two side boards being concaved around to form a sealing slot, the sealing ring sheathes an outside of a front end of the external housing and the sealing ring is thicker than the external housing.

9. The water-proof connector as claimed in claim 1, further including a stiffening cap having a stiffening board, a rear edge of the stiffening board extending rearward and further extending to two sides in transverse direction to form a pair of fixing boards, wherein two opposite sides of a top face of the tongue board connecting to the side edges of the tongue board protruding outward to form a pair of fixing lumps, wherein the stiffening board defining a pair of fixing slots corresponding to the fixing lumps of the tongue board of the internal housing, the fixing lumps of the tongue board of the internal housing are fastened in the fixing slots of the stiffening board.

10. The water-proof connector as claimed in claim 9, wherein a top face of the tongue board protruding upward to form a plurality of convex hulls, the stiffening board defining a plurality of opening slots corresponding to the convex hulls of the tongue board of the internal housing, the convex hulls of the tongue board of the internal housing are fastened in the opening slots of the stiffening board of the stiffening cap.
